(19) United States
(12) Patent Application Publication
(10) Pub. No.: US 2007/0298934 A1
(43) Pub. Date: Dec. 27, 2007

(54) Hand Control Apparatus in A Vehicle

(76) Inventor: Zhide Feng, Troy, MI (US)

Correspondence Address: PATWRITE LLC, 408 W. MAIN ST., MARSHALLTOWN, IA, 50158-5759, US

(21) Appl. No.: 11/756,633

(22) Filed: Jun. 1, 2007

Related U.S. Application Data
(60) Provisional application No. 60/816,009, filed on Jun. 22, 2006.

(51) Int. Cl. F02D 11/02

(52) U.S. Cl. 477/209

(57) ABSTRACT

A steering column mount or instrument panel mount push-pull style hand control apparatus for controlling a vehicle by hands only of a special driver. A operation lever is cross-car (left-right) oriented and pivotally mount at its mid-section through a pivot bracket to said steering column or to said instrument panel. A brake lever and a accelerator at both of their near ends are pivoted to said bracket and both under said operation lever, with one oriented to the left and another to the right. Therefore, when the free end of said operation lever is pressed down, it will push down said far end of brake lever and an OEM brake arm through a brake rod. Similarly, when the free end operation lever is lifted up, it will push down an OEM accelerator arm through an accelerator rod.

### RELATED APPLICATIONS

This application is related to and claims convention priority and herein incorporates by reference on U.S. Provisional Patent Application No. 60/816,009 filed on Jun. 22, 2006 (Hand Control Apparatus in A Vehicle).

### FIELD OF THE INVENTION

The present invention relates in general to the provision of means of interfacing mechanism for a driver using hands to replace foots to operate a vehicle.

### BACKGROUND OF THE INVENTION

Applicant is aware of a number of both patented and unpatented devices for manually controlling the brake and/or accelerator pedals of automotive vehicles. The inventors and the respective patent numbers of which applicant is aware of as follows:

Pawl U.S. Pat. No. 3,275,093

Bhattacharya U.S. Pat. No. 4,143,734

Appley U.S. Pat. No. 4,228,865

Dowden, et al. U.S. Pat. No. 4,438,835

Johnson, et al. U.S. Pat. No. 4,476,954

Ahnafield U.S. Pat. No. 4,722,416

### SUMMARY OF THE INVENTION

A steering column mount or instrument panel mount push-pull style hand control apparatus for controlling a vehicle by hands only of a special driver. A operation lever is cross-car (left-right) oriented and pivotally mount at its mid-section through a pivot bracket to said steering column or to said instrument panel. A brake lever and a accelerator at both of their near ends are pivoted to said bracket and both under said operation lever, with one oriented to the left and another to the right. Therefore, when the free end of said operation lever is pressed down, it will push down said far end of brake lever and an OEM brake arm through a brake rod. Similarly, when the free end operation lever is lifted up, it will push down an OEM accelerator arm through an accelerator rod.

Other features and advantages of the instant invention will become apparent from the following description of the invention which refers to the accompanying drawings.

### BRIEF DESCRIPTION OF THE DRAWINGS

FIG. 1 is a perspective view of an embodiment according to the present invention.

FIG. 2 is another perspective view of an embodiment according to the present invention.

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

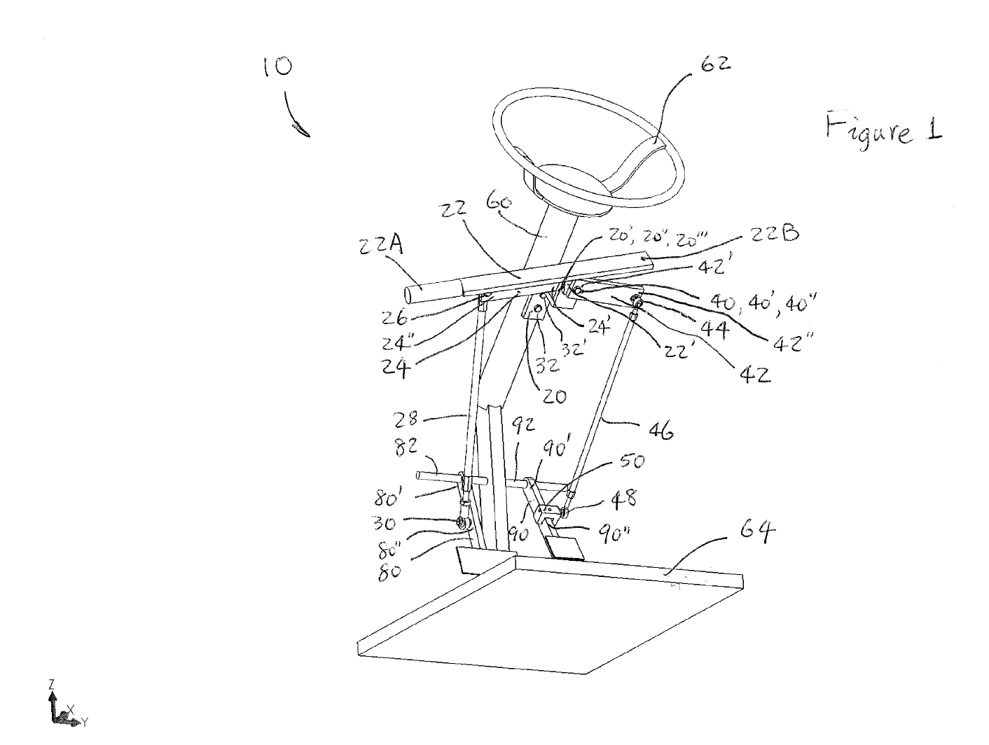

As shown in FIG. 1, a conventional (not for special drivers specially) vehicle usually has floor panel 64, a brake pedal 80 mounted on floor panel 64 through brake pedal first pivot 82, and has an accelerator pedal 90 mounted on floor panel 64 through accelerator pedal first pivot 92. The vehicle usually also has a steering column 60, a steering wheel 62 and instrument panel (not shown) beneath steering wheel 62.

When a conventional driver press down brake pedal 80 by his/her foot, the vehicle will be slowed down up to full stop. When the conventional driver press down accelerator pedal 90 by his/her foot, the vehicle will be usually speeded up to higher velocity.

This apparatus 10 will let some special drivers use a hand to replace a foot to drive a conventional vehicle when this apparatus 10 is installed to a conventional vehicle.

A pivot bracket 20 can be fixed to steering column 60 or instrument panel through pivot bracket fastener 32 and 32′. A first pivot location 20′ of pivot bracket 20 is installed with operation lever 22 by fastener 40 in its mid-section 22′, which has significant distances from both its left and right ends of operation lever 22. Said operation lever 22 is usually basically oriented in cross-car direction.

The brake lever 24 is basically oriented in cross-car direction too. Its near-end 24′ is connected to a second pivot location 20″ of pivot bracket 20 by fastener 40′, which is usually co-instant with first pivot location 20′. Brake lever 24 is basically arranged under operation lever 22, therefore, when operation lever 22 is pressed down at its brake end 22A, brake lever 24 is indirectly pressed down too. But when said brake end 22A is lifted up, brake lever 24 do not have to follow the movement of operation lever 22 (not moving up necessary).

The top end of a brake rod 28 is attached to a far-end 24″ of brake lever 24 through joint (usually universal joint) 26.

Usually one end 80′ of the OEM brake pedal 80 is attached to floor panel 64 (or through some bracket) by brake pedal first pivot 82. A second location 80″ (which is different from said end 80′) is connected with the lower end of brake rod 28 through joint (usually universal joint) 30.

Therefore, when brake end 22A of operation lever 22 is pressed down, it will drive down brake lever 24, brake rod 28, and press down brake pedal 80, and the vehicle will be braked.

An accelerator lever 42 is also basically oriented in cross-car direction too but in opposite direction of brake lever 24. Its near-end 42′ is connected to a third pivot location 20′″ of pivot bracket 20 by fastener 40″, which is usually co-instant with first pivot location 20′. Accelerator lever 42 is basically arranged under operation lever 22, therefore, when accelerator end 22B is pressed down (operated by lifting brake end 22A), accelerator lever 42 is indirectly pressed down at its far-end 42″ too. But when accelerator end 22B is lifted up (operated by press down brake end 22A), accelerator lever 42 do not have to follow the movement of accelerator end 22B (not moving up necessary).

The top end of an accelerator rod 46 is attached to the far-end 42″ of accelerator lever 42 through joint (usually universal joint) 44.

Usually one end 90′ of the OEM accelerator pedal 90 is attached to floor panel 64 (or through some bracket) by accelerator pedal first pivot 92. A second location 90″ (which is different from the end 90′) is connected with the lower end of accelerator rod 46 through joint (usually universal joint) 48 and sometimes also through bracket 50.

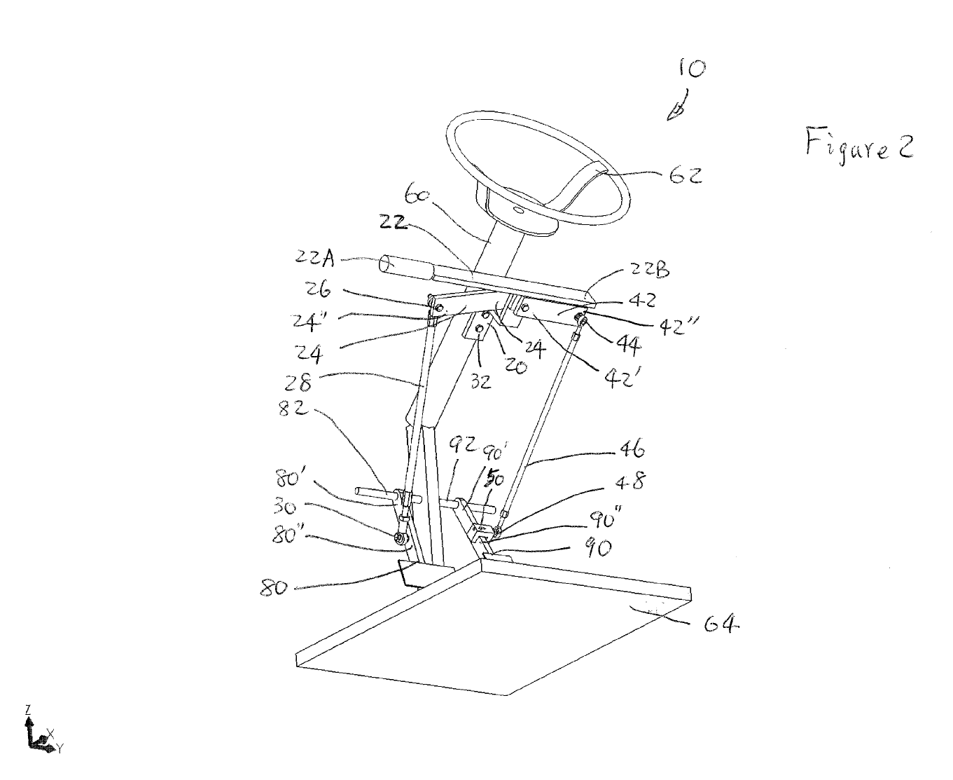

Therefore, when accelerator end 22B is pressed down by lifting brake end 22A of operation lever 22, it will drive down accelerator lever 42, accelerator rod 46, and press down accelerator pedal 90, and the vehicle will be accelerated. (see FIG. 2).

At this moment the operation lever 22 is departed from joint 26.

In the case pressing down brake end 22A, accelerator lever 42 is departing from operation lever 22.

Therefore when the beginning location among operation lever 22, brake lever 24 and accelerator lever 42 are carefully adjusted, operation of accelerating and operation of braking will be contradicted with each other. In other words, when brake pedal 80 is pressed down, the accelerator pedal 90 is automatically released (no acceleration action); when accelerator pedal 90 is pressed down, the brake pedal is automatically released (no braking action).

This kind of means operating a vehicle is usually called as push-pull style hand control means, whose operation for acceleration and braking is opposite to each other. Theoretically there will be no mistake to operate this kind of apparatus to actuate both brake and accelerator at the same time.

Although the instant invention has been described in relation to particular embodiments thereof, many other variations and modifications and other uses will become apparent to those skilled in the art.

What is claimed is:

1. A hand control means for helping a special driver to operate a conventional vehicle by hands, said vehicle usually having a floor panel, a brake pedal mounted on floor panel through a brake pedal first pivot, said brake pedal also having a second location which is usually lower and more rearward than the location of said first pivot;
said vehicle also having an accelerator pedal mounted on said floor panel through a accelerator pedal first pivot; said accelerator pedal also having a second location which is usually lower and more rearward than the location of said first pivot;
the vehicle usually also having a steering column and instrument panel beneath said steering wheel, said hand control means comprising:
an operation lever, said operation lever being basically oriented in cross-car direction, and having an brake end and accelerator end, and a mid-section which has significantly distance from either ends of said operation lever;
an operation lever fastener pivotally mounting said mid-section of said operation lever to one selected from said column and said instrument panel;
a brake lever having a near-end and a far-end, said brake lever having basically same orientation as said operation lever and being adjacent to said operation lever in location;
a brake lever near-end fastener attaching said brake lever pivotally to one selected from said column and said instrument panel;
a brake rod having top end and lower end;
a brake lever far-end fastener attaching said brake rod at its top end to said far-end of said brake lever;
a brake pedal second fastener attaching said lower end of said brake rod to said second location of said brake pedal;
an accelerator lever having a near-end and a far-end, said accelerator lever having basically opposite orientation as said brake lever and being adjacent to said operation lever in location;
an accelerator lever near-end fastener attaching said accelerator lever at its near end pivotally to one selected from said column and said instrument panel;
an accelerator rod having top end and lower end;
an accelerator lever far-end fastener attaching said accelerator rod at its top end to said far-end of said brake lever;
an accelerator pedal second fastener attaching said lower end of said accelerator rod to said second location of said accelerator pedal;
whereby when said operation lever is rotated around said operation lever fastener in one direction, it will create braking action without accelerating action to said vehicle; while said operation lever is turned in opposite direction, it will create accelerating action without braking action to said vehicle.

2. A hand control means according to claim 1 further comprising a pivot bracket, and said pivot bracket being connected to one selected from said steering column and said instrument panel, said mid-section of said operation lever, said near end of said brake lever and said near end of said accelerator lever being connected to said pivot bracket first and then to said one selected from said steering column and said instrument panel through said pivot bracket.

3. A hand control means for helping a special driver to operate a conventional vehicle by hands, said vehicle usually having a floor panel, a brake pedal mounted on floor panel through a brake pedal first pivot, said brake pedal also having a second location which is usually lower and more rearward than the location of said first pivot;
said vehicle also having an accelerator pedal mounted on said floor panel through a accelerator pedal first pivot; said accelerator pedal also having a second location which is usually lower and more rearward than the location of said first pivot;
the vehicle usually also having a steering column and instrument panel beneath said steering wheel, said hand control means comprising:
an operation lever, said operation lever being basically oriented in cross-car direction, and having an brake end and accelerator end, and a mid-section which has significantly distance from either ends of said operation lever;
an operation lever fastener pivotally mounting said mid-section of said operation lever to one selected from said column and said instrument panel;
a brake lever having a near-end and a far-end, said brake lever having basically same orientation as said operation lever and being adjacent to said operation lever in location;
a brake lever near-end fastener attaching said brake lever pivotally to one selected from said column and said instrument panel;
a brake rod having top end and lower end;
a brake lever far-end fastener attaching universally said brake rod at its top end to said far-end of said brake lever;
a brake pedal second fastener attaching said lower end of said brake rod universally to said second location of said brake pedal;
an accelerator lever having a near-end and a far-end, said accelerator lever having basically opposite orientation as said brake lever and being adjacent to said operation lever in location;
an accelerator lever near-end fastener attaching said accelerator lever at its near end pivotally to one selected from said column and said instrument panel;
an accelerator rod having top end and lower end;
an accelerator lever far-end fastener attaching universally said accelerator rod at its top end to said far-end of said brake lever;
an accelerator pedal second fastener attaching said lower end of said accelerator rod universally to said second location of said accelerator pedal;
whereby when said operation lever is rotated around said operation lever fastener in one direction, it will create braking action without accelerating action to said vehicle; while said operation lever is turned in opposite direction, it will create accelerating action without braking action to said vehicle.
